(19) United States
(12) Patent Application Publication
(10) Pub. No.: US 2025/0303926 A1
(43) Pub. Date: Oct. 2, 2025

(54) Kinetic Energy System for Continuous Electric Vehicle Operation

(71) Applicant: John Cappello, Lantana, TX (US)

(72) Inventor: John Cappello, Lantana, TX (US)

(21) Appl. No.: 19/096,952

(22) Filed: Apr. 1, 2025

Related U.S. Application Data
(60) Provisional application No. 63/572,938, filed on Apr. 2, 2024.

(51) Int. Cl. B60L 58/18; B60L 7/10; B60L 53/51; B60L 53/57; B60L 58/14; H02J 7/14; H02J 7/35

(52) U.S. Cl. CPC B60L 58/18; B60L 7/10; B60L 53/51; B60L 53/57; B60L 58/14; H02J 7/1423; H02J 7/35

(57) ABSTRACT

The present invention is a self-charging electric vehicle system. The system comprises a pair of rechargeable batteries, an electric generator, and a battery monitoring module. The batteries alternately provide power to the electric motor of the vehicle, enabling at least one battery to be always available for operation while the other is being recharged. The generator is operatively connected to the vehicle's wheels and braking system and converts kinetic energy from motion into electrical energy to recharge the batteries. The battery monitoring module manages energy flow, monitors battery charge levels, and automatically (i.e., autonomously) switches between batteries when the active battery's charge falls below a predetermined threshold.

### CROSS-REFERENCE TO RELATED APPLICATION

The present application claims priority to, and the benefit of, U.S. Provisional Application No. 63/572,938 which was filed on Apr. 2, 2024 and is incorporated herein by reference in its entirety.

### FIELD OF THE INVENTION

The present invention generally relates to self-charging systems for electric vehicles (EVs). More specifically, the invention relates to a dual-battery self-charging system designed to eliminate dependency on external charging stations by incorporating an energy-harvesting mechanism. The system includes a pair of rechargeable batteries, with one battery actively powering the vehicle while the other is recharged using an electric generator. The generator is coupled to the vehicle's wheels and braking system and converts kinetic energy into electrical energy for recharging the batteries. A battery monitoring module manages energy flow, monitors battery charge levels, and switches between batteries when required to operate the vehicle. Accordingly, the present disclosure makes specific reference thereto. Nonetheless, it is to be appreciated that aspects of the present invention are also equally applicable to other like applications, devices, and methods of manufacture.

### BACKGROUND

By way of background, Electric vehicles (EVs) have gained significant popularity in recent years as EVs are eco-friendly nature and reduce or eliminate emissions of pollutants and greenhouse gases. As a sustainable alternative to traditional internal combustion engine vehicles, EVs contribute to decreasing the world's reliance on gasoline and fossil fuels and play a critical role in addressing climate change and energy sustainability. Additionally, EVs have lower operating costs compared to conventional vehicles, offering long-term savings to users through reduced fuel expenses and maintenance requirements.

Despite these advantages, current EV technology has a major limitation of limited battery capacity which requires individuals to stop and recharge their EV batteries at external charging stations. This process is not only time-consuming but also poses difficulties in remote or underserved areas where charging infrastructure is sparse. Drivers often experience range anxiety, a concern about when and where they will be able to recharge their vehicle. Furthermore, the growing adoption of EVs can place a significant strain on existing power grids, which are often already under pressure. Individuals desire a charging solution for electric vehicles that obviates the need for an electric vehicle to stop and recharge and provides a fully charged battery available at all times.

Therefore, there exists a long-felt need in the art for a self-charging system for electric vehicles (EVs) that obviates the dependency on external charging stations. There is a long-felt need for an energy solution that enables EVs to continuously recharge their batteries while in motion, thereby enhancing the practicality and usability of electric vehicles. Additionally, there is a long-felt need for a system that reduces range anxiety by ensuring that drivers always have access to a charged battery. Further, there exists a long-felt need for a sustainable and efficient system that minimizes the burden on already-strained power grids, promoting energy independence and environmental sustainability. Furthermore, there is a long-felt need in the art for an EV charging solution that uses two batteries and enables one battery to be recharged while the vehicle is in operation. Finally, there is a long-felt need in the art for an EV charging system that obviates the need for an electric vehicle to stop and recharge and provides continuous charging of battery of the EV.

The subject matter disclosed and claimed herein, in one embodiment, comprises a self-charging electric vehicle system. The system includes a dual-battery configuration where one battery is actively supplying power to the vehicle while the other battery is being recharged. The system further includes an electric generator, coupled to the vehicle's wheels and braking system, which converts kinetic energy from motion into electrical energy to recharge the non-operating battery. A battery monitoring module is included to manage the flow of energy, monitor charge levels, and switch between the batteries when the active battery's charge falls below a predetermined threshold. The system provides continuous operation by maintaining one battery for powering the vehicle and the other for recharging, eliminating the need for external charging stops.

In this manner, the system of the present invention accomplishes all of the foregoing objectives and provides a practical, energy-efficient solution for enhancing the usability of electric vehicles. The dual-battery system provides uninterrupted operation and reduces range anxiety, making EVs more reliable for users. Additionally, the kinetic energy harvesting generator and intelligent battery monitoring module improve energy efficiency and battery lifespan, offering a sustainable alternative to traditional EVs reliant on external charging infrastructure. The system is adaptable to various vehicle designs and includes backward compatibility with conventional charging stations for added flexibility. The system utilizes the movement of the vehicle to power the generator to recharge the batteries.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a self-charging electric vehicle system. The system comprises a pair of rechargeable batteries, wherein each battery is configured to provide power to an electric motor of the electric vehicle and to be recharged alternately, an electric generator is operatively coupled to at least one wheel and a brake of the electric vehicle, the generator is configured to convert kinetic energy from motion of the vehicle into electrical energy, a battery monitoring module is configured to monitor a charge level of each rechargeable battery, direct electrical energy generated by the electric generator to recharge a non-operating battery, and automatically switch between the rechargeable batteries to supply uninterrupted power to the electric motor when the charge level of an active battery falls below a predetermined threshold.

In another aspect, an electric vehicle is disclosed. The electric vehicle includes a self-charging system, the self-charging system comprises a pair of rechargeable batteries, each battery is configured to alternately supply power to an electric motor of the vehicle while the other is being recharged. An electric generator is operatively connected to at least one wheel and a braking system of the vehicle, the generator is configured to harness kinetic energy from vehicle motion and convert it into electrical energy for recharging a battery. A battery monitoring module is configured to monitor charge levels of the rechargeable batteries, direct electrical energy from the generator to the non-operating battery and automatically switch between the batteries to provide uninterrupted operation of the vehicle.

In another embodiment, a method for operating a self-charging system in an electric vehicle is described. The method includes the steps of detecting, by a battery monitoring module, an active battery from a pair of rechargeable batteries configured to provide power to an electric motor of the vehicle, harnessing kinetic energy, via an electric generator operatively connected to at least one wheel and a braking system of the vehicle, and converting the kinetic energy into electrical energy, directing the electrical energy generated by the generator to recharge a non- operating battery, monitoring charge levels of the rechargeable batteries, including the active battery and the non-operating battery, via the battery monitoring module, and switching the power supply from the active battery to the non-operating battery when a charge level of the active battery falls below a predetermined threshold.

In one embodiment, the electric generator is further configured to harvest energy from both the rotational motion of the vehicle's tires and vibrations caused by irregular road surfaces, thereby increasing energy recovery efficiency.

In yet another aspect, the battery monitoring module is further configured to communicate charge levels, state-of-health, and other performance metrics of the rechargeable batteries to a user via an application on a connected smartphone.

In another aspect, the system dynamically adjusts the allocation of electrical energy generated by the electric generator between recharging the non-operating battery and powering auxiliary systems of the vehicle, based on real-time power demands of the auxiliary systems.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagram view of electric vehicle self-charging system of the present invention in accordance with the disclosed structure;

FIG. 2 illustrates a perspective view of one embodiment of positioning of different components of the electric vehicle self-charging system in accordance with the disclosed structure;

FIG. 3 illustrates another embodiment of the self-charging system of the present invention in accordance with the disclosed structure; and

FIG. 4 illustrates a flow chart depicting a process of recharging of the batteries included in the electricity generation and storage system in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a self-charging system for electric vehicles (EVs) that obviates the dependency on external charging stations. There is a long-felt need for an energy solution that enables EVs to continuously recharge their batteries while in motion, thereby enhancing the practicality and usability of electric vehicles. Additionally, there is a long-felt need for a system that reduces range anxiety by ensuring that drivers always have access to a charged battery. Further, there exists a long-felt need for a sustainable and efficient system that minimizes the burden on already-strained power grids, promoting energy independence and environmental sustainability. Furthermore, there is a long-felt need in the art for an EV charging solution that uses two batteries and enables one battery to be recharged while the vehicle is in operation. Finally, there is a long-felt need in the art for an EV charging system that obviates the need for an electric vehicle to stop and recharge and provides continuous charging of battery of the EV.

The present invention, in one exemplary embodiment, is an electric vehicle. The electric vehicle includes a self-charging system, the self-charging system comprises a pair of rechargeable batteries, each battery is configured to alternately supply power to an electric motor of the vehicle while the other is being recharged. An electric generator is operatively connected to at least one wheel and a braking system of the vehicle, the generator is configured to harness kinetic energy from vehicle motion and convert it into electrical energy for recharging a battery. A battery monitoring module is configured to monitor charge levels of the rechargeable batteries, direct electrical energy from the generator to the non-operating battery and automatically switch between the batteries to provide uninterrupted operation of the vehicle.

Reference will now be made in detail to the present preferred embodiments of the invention, examples of which are illustrated in the accompanying drawings. Wherever possible, the same reference numerals are used in the drawings and the description to refer to the same or like parts.

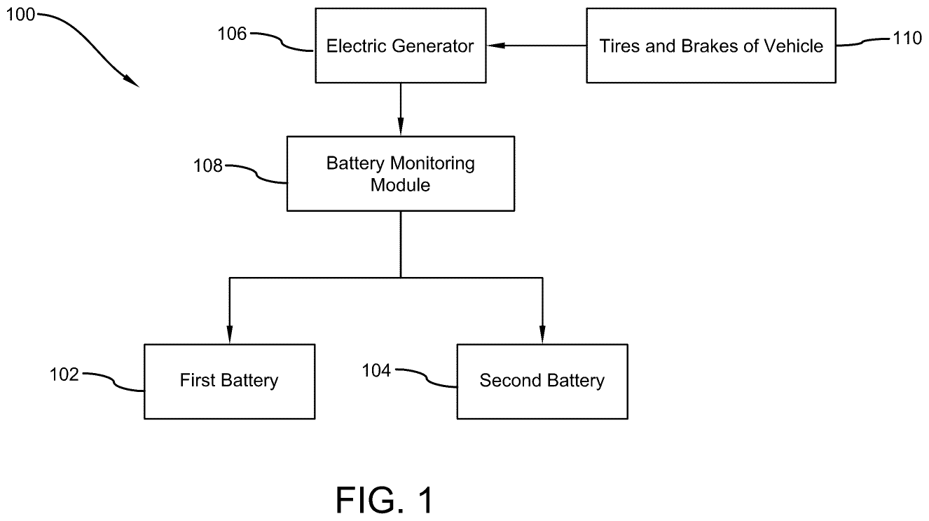

Referring initially to the drawings, FIG. 1 illustrates a diagram view of electric vehicle self-charging system of the present invention in accordance with the disclosed structure. The electric vehicle self-charging system 100 of the present invention provides energy sustainability for electric vehicles (EVs). The system 100 includes a pair of batteries as described later in the disclosure and enables the vehicle to recharge the batteries while the vehicle is in motion, thereby eliminating the dependency on external charging stations. More specifically, the system 100 includes a first rechargeable battery 102 and a second rechargeable battery 104. In use, only one of the batteries 102, 104 is used for providing electric power to the electric vehicle and the other battery is automatically (i.e., autonomously) recharged. The dual-battery system provides that the vehicle always has a charged battery available for operation.

The system 100 includes an electric generator 106 which is configured to convert kinetic energy of motion of the vehicle in which the system 100 is installed into electrical energy. The electrical energy generated by the electric generator 106 is used for recharging the batteries 102, 104. In the preferred embodiment, the electric generator 106 is coupled to tires or wheels and brake system 110 of the vehicle and as the vehicle moves, the generator 106 harnesses kinetic energy from the rotation of the tires and the braking process.

A battery monitoring module 108 is coupled to the batteries 102, 104 and is configured to direct electrical energy from the generator 106 to the battery which is non-operating and currently not being used for running (i.e., powering) the electric vehicle. The battery monitoring module 108 is also adapted to monitor the battery charge level of the battery (active battery) being used for running (i.e., powering) the electric vehicle. Further, the battery monitoring module 108 automatically (i.e., autonomously) switches the battery used for running (i.e., powering) the electric vehicle when the battery charge level of the active battery falls below a threshold level such as 10% of the total battery charge level. It should be noted that only one battery of the pair of the batteries is used for running (i.e., powering) the vehicle and the other battery is recharged simultaneously from the electrical energy generated by the electric generator 106. The switching mechanism between the batteries 102, 104 by the battery monitoring module 108 ensures that the transition between batteries 102, 104 is smooth and real-time to provide uninterrupted power to the vehicle's electric motor.

The battery monitoring module 108 is also configured to monitor state-of-health of both the batteries 102, 104 and regulate charging and discharging cycles to improved lifespan of both the batteries 102, 104. It is to be appreciated that both batteries 102, 104 can be charged using a charging plug 107 attached to a charging station. Charging both batteries via a charging station can be done to initiate a trip having both batteries at full charge. Alternatively, the vehicle can include solar panels (not illustrated) to supplement charging of the batteries 102, 104 while running the electric vehicle or while the electric vehicle is at rest.

Each battery of the rechargeable batteries 102, 104 is one of Li-Ion battery, Solid-State battery, and Lithium Iron Phosphate battery. Further, each battery independently can provide power in the range 50 kWh and 110 kWh. Also, each battery is adapted to handle high charging rates such as 3C charging rate to accept rapid and frequent energy input from the brakes and tires of a vehicle. The rechargeable batteries 102, 104 are made of fire-resistant materials and have embedded overcharge protection to prevent damage due to excessive charging.

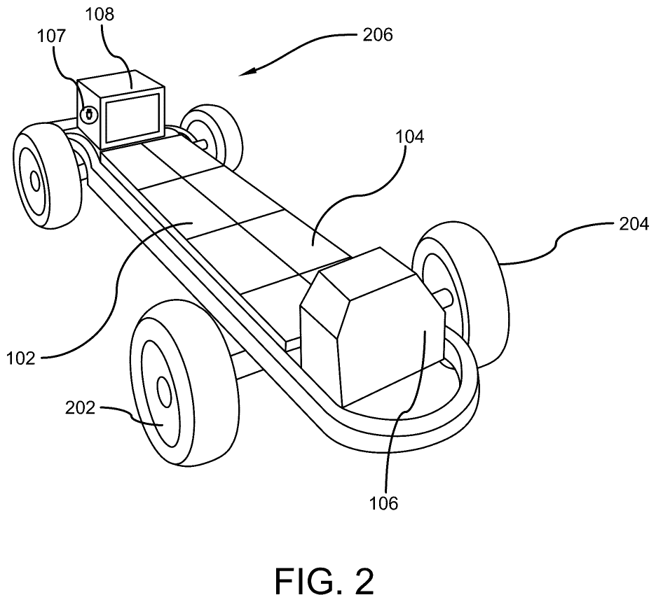

FIG. 2 illustrates a perspective view of one embodiment of positioning of different components of the electric vehicle self-charging system 100 in accordance with the disclosed structure. In the present embodiment, the generator 106 is positioned near the front wheels 202, 204 of the vehicle 206 such that the generator 106 is rotated when wheels 202, 204 rotate. Also, depending on the design of the vehicle 206 and use of the braking system, the generator 106 rotates and generates electrical energy.

The batteries 102, 104 can be of any shape and size and are internally coupled to the generator 106. The batteries 102, 104 can be modular and may include a plurality of cells wherein one or more cells can be replaced individually to maintain lifespan of the batteries 102, 104. The battery monitoring module 108 automatically (i.e., autonomously) controls the switching between the batteries 102, 104 to maintain one battery for providing power to the vehicle and the other battery on recharging using the electrical power of the generator 106. The batteries 102, 104 are configured with a charging plug 107 to be recharged using a conventional EV battery charging station for providing backward compatibility with the conventional charging stations.

It should be noted that different components of the electric vehicle self-charging system 100 can be positioned at different positions inside a vehicle and is based on the size and design of the vehicle. Although in the present embodiment, the batteries 102, 104 are illustrated adjacent to each other, however, in some embodiments, the batteries can be positioned in front and at rear of the vehicle.

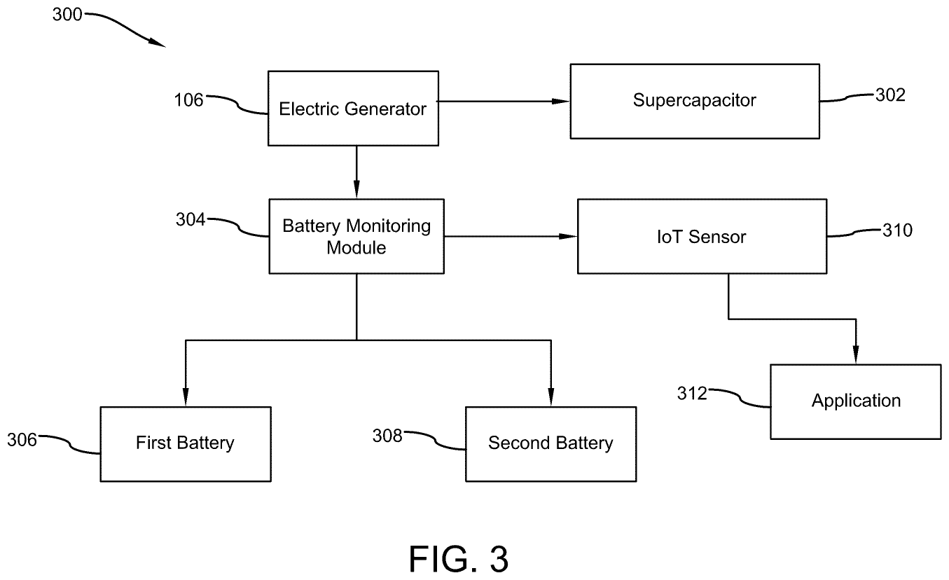

FIG. 3 illustrates another embodiment of the self-charging system of the present invention in accordance with the disclosed structure. In the present embodiment, at least one supercapacitor 302 is used to capture bursts of energy from regenerative braking of a vehicle and the energy stored in the supercapacitor 302 is transferred at a constant rate as preset by the battery monitoring module 304 to the batteries 306, 308. The batteries 306, 308 can be of two different technologies such as the battery 306 is a Li-Ion battery and the battery 308 is a solid-state battery to optimize performance based on driving conditions.

At least one IoT sensor 310 is disposed in the battery monitoring module 304 and is configured to communicate battery performance and battery level to a compatible smartphone application 312. In some embodiments, the application 312 can display energy levels of the batteries of vehicles across a fleet of vehicles.

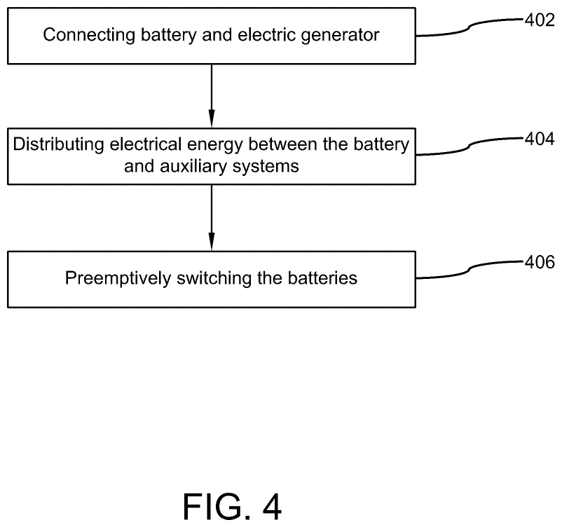

FIG. 4 illustrates a flow chart depicting a process of recharging of the batteries included in the dual-battery kinetic energy harvesting system in accordance with one embodiment of the present invention. Initially, the battery monitoring module 108 detects the active battery and activates the connection of the other battery and the electric generator (Step 402). Then, the battery monitoring module 108 distributes the electrical energy generated by the generator between recharging the battery and powering auxiliary systems like lighting or HVAC (Step 404). The battery monitoring module 108 may include an algorithm which has the power requirements of the auxiliary systems of the vehicle and is used for distribution of the electrical energy. Thereafter, the battery monitoring module 108 preemptively switches between the batteries for providing consistent electrical power to the vehicle for the operation thereof (Step 406).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “electric vehicle self-charging system”, “self-charging system”, “self-charging energy management system for electric vehicles”, “dual-battery kinetic energy harvesting system”, and “system” are interchangeable and refer to the self-charging energy management system for electric vehicles 100, 300 of the present invention.

Notwithstanding the forgoing, the self-charging energy management system for electric vehicles 100, 300 of the present invention can be of any suitable size and configuration as is known in the art without affecting the overall concept of the invention, provided that it accomplishes the above stated objectives. One of ordinary skill in the art will appreciate that the self-charging energy management system for electric vehicles 100, 300 as shown in the FIGS. are for illustrative purposes only, and that many other sizes and shapes of the self-charging energy management system for electric vehicles 100, 300 are well within the scope of the present disclosure. Although the dimensions of the self-charging energy management system for electric vehicles 100, 300 are important design parameters for user convenience, the self-charging energy management system for electric vehicles 100, 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric vehicle self-charging system comprising:
a first rechargeable battery and a second rechargeable battery;
an electric generator configured to convert kinetic energy of motion of a vehicle into electrical energy; and
a battery monitoring module;
wherein at least one of said first rechargeable battery and said second rechargeable battery actively providing power to an electric vehicle;
wherein at least one of said first rechargeable battery and said second rechargeable battery actively autonomously charging;
wherein said electrical energy generated by said electric generator recharges one of said first rechargeable battery and said second rechargeable battery; and
further wherein simultaneously one of said first rechargeable battery and said second rechargeable battery is operating while the other one of said first rechargeable battery and said second rechargeable battery is charging.

2. The electric vehicle self-charging system of claim 1, wherein said electric generator coupled to a wheel and brake system of the vehicle.

3. The electric vehicle self-charging system of claim 1, wherein said electrical generator connected to at least one of a wheel and a brake of the vehicle to harness said kinetic energy of motion from rotation of said wheel and braking of said brake of the vehicle.

4. The electric vehicle self-charging system of claim 3, wherein said battery monitoring module is coupled to said first rechargeable battery and said second rechargeable battery.

5. The electric vehicle self-charging system of claim 4, wherein said battery monitoring module directs electrical energy from said electric generator to said charging one of said first rechargeable battery and said second rechargeable battery.

6. The electric vehicle self-charging system of claim 5, wherein said battery monitoring module monitors a battery charge level of an operating one of said first rechargeable battery and said second rechargeable battery.

7. The electric vehicle self-charging system of claim 6, wherein said operating one of said first rechargeable battery and said second rechargeable battery powers the electric vehicle.

8. The electric vehicle self-charging system of claim 7, wherein said battery monitoring module monitors a battery charge level of said operating one of said first rechargeable battery and said second rechargeable battery, and further wherein said battery monitoring module switches from said operating one of said first rechargeable battery and said second rechargeable battery to another of said first rechargeable battery and said second rechargeable battery when a threshold charge level of said operating one of said first rechargeable battery and said second rechargeable battery falls below a predetermined threshold charge level.

9. The electric vehicle self-charging system of claim 8, wherein said predetermined threshold charge level is 10%.

10. The electric vehicle self-charging system of claim 9, wherein said switching is real-time to provide uninterrupted power to the vehicle.

11. An electric vehicle self-charging system comprising:
a first rechargeable battery and a second rechargeable battery;
an electric generator configured to convert kinetic energy of motion of a vehicle into electrical energy; and
a battery monitoring module;
wherein at least one of said first rechargeable battery and said second rechargeable battery actively providing power to an electric vehicle;
wherein at least one of said first rechargeable battery and said second rechargeable battery actively autonomously charging;
wherein said electrical energy generated by said electric generator recharges one of said first rechargeable battery and said second rechargeable battery;
wherein said battery monitoring module is coupled to said first rechargeable battery and said second rechargeable battery;
wherein said battery monitoring module directs electrical energy from said electric generator to said charging one of said first rechargeable battery and said second rechargeable battery; and
further wherein simultaneously one of said first rechargeable battery and said second rechargeable battery is operating while the other one of said first rechargeable battery and said second rechargeable battery is charging.

12. The electric vehicle self-charging system of claim 11, wherein said electrical generator connected to at least one of said wheel and said brake of the vehicle to harness said kinetic energy of motion from rotation of said wheel and braking of said brake of the vehicle.

13. The electric vehicle self-charging system of claim 12, wherein said battery monitoring module monitors a battery charge level of an operating one of said first rechargeable battery and said second rechargeable battery.

14. The electric vehicle self-charging system of claim 13, wherein said operating one of said first rechargeable battery and said second rechargeable battery powers the electric vehicle.

15. The electric vehicle self-charging system of claim 14, wherein said battery monitoring module monitors a battery charge level of said operating one of said first rechargeable battery and said second rechargeable battery, and further wherein said battery monitoring module switches from said operating one of said first rechargeable battery and said second rechargeable battery to another of said first rechargeable battery and said second rechargeable battery when a threshold charge level of said operating one of said first rechargeable battery and said second rechargeable battery falls below a predetermined threshold charge level.

16. The electric vehicle self-charging system of claim 15, wherein said first rechargeable battery and said second rechargeable battery selectively rechargeable with another power source selected from the group consisting of a battery charging station and a solar panel.

17. The electric vehicle self-charging system of claim 16, wherein said switching is real-time to provide uninterrupted power to the vehicle.

18. An electric vehicle self-charging system comprising:
a first rechargeable battery and a second rechargeable battery;
an electric generator configured to convert kinetic energy of motion of a vehicle into electrical energy; and
a battery monitoring module;
wherein at least one of said first rechargeable battery and said second rechargeable battery actively providing power to an electric vehicle;
wherein at least one of said first rechargeable battery and said second rechargeable battery actively autonomously charging;
wherein said electrical energy generated by said electric generator recharges one of said first rechargeable battery and said second rechargeable battery;
wherein said battery monitoring module is coupled to said first rechargeable battery and said second rechargeable battery;
wherein said battery monitoring module directs electrical energy from said electric generator to said charging one of said first rechargeable battery and said second rechargeable battery;
wherein simultaneously one of said first rechargeable battery and said second rechargeable battery is operating while the other one of said first rechargeable battery and said second rechargeable battery is charging; and
further wherein one of said first rechargeable battery and said second rechargeable battery is a Li-Ion battery and another of said first rechargeable battery and said second rechargeable battery is a solid-state battery.

19. The electric vehicle self-charging system of claim 18, wherein said electrical generator connected to at least one of said wheel and said brake of the vehicle to harness said kinetic energy of motion from rotation of said wheel and braking of said brake of the vehicle.

20. The electric vehicle self-charging system of claim 19, wherein said battery monitoring module monitors a battery charge level of said operating one of said first rechargeable battery and said second rechargeable battery, and further wherein said battery monitoring module switches from said operating one of said first rechargeable battery and said second rechargeable battery to another of said first rechargeable battery and said second rechargeable battery when a threshold charge level of said operating one of said first rechargeable battery and said second rechargeable battery falls below a predetermined threshold charge level.
